(19) United States
(12) Patent Application Publication
(10) Pub. No.: US 2007/0088456 A1
(43) Pub. Date: Apr. 19, 2007

(54) SYSTEM AND METHOD FOR TOOL POINT PREDICTION USING MULTI-COMPONENT RECEPTANCE COUPLING SUBSTRUCTURE ANALYSIS

(75) Inventors: Tony L. Schmitz, Gainesville, FL (US); Gregory S. Duncan, Gainesville, FL (US)

Correspondence Address: AKERMAN SENTERFITT, P.O. BOX 3188, WEST PALM BEACH, FL, 33402-3188, US

(73) Assignee: University of Florida Research Foundation, Inc., Gainesville, FL (US)

(21) Appl. No.: 11/537,859

(22) Filed: Oct. 2, 2006

Related U.S. Application Data
(63) Continuation-in-part of application No. PCT/US06/13089, filed on Apr. 7, 2006.
(60) Provisional application No. 60/669,093, filed on Apr. 7, 2005.

(51) Int. Cl. G06F 19/00

(52) U.S. Cl. 700/175; 700/177

(57) ABSTRACT

A method for predicting a tool point response of a spindle-holder-tool assembly to be used for high-speed machining applications is provided. The method includes determining direct and cross displacement-to-force receptances of a standard holder secured in the spindle based upon measurements of displacement-to-force taken at different rotating speeds of the spindle. The method also includes determining direct receptances at a free end of the standard holder based upon the determined direct and cross displacement-to-force receptances of the standard holder. Additionally, the method includes performing an inverse receptance coupling to simulate a decomposition of the standard holder into multiple subassemblies, the subassemblies including a spindle-holder base subassembly and an extended holder subassembly. The method further includes determining spindle-holder base subassembly receptances based upon the simulated decomposition of the standard holder.

### RELATED APPLICATIONS

This application is a continuation-in-part of PCT Application PCT/US2006/013089, titled System and Method for Tool Point Prediction Using Multi-Component Receptance Coupling Substructure Analysis, filed Apr. 7, 2006, claiming priority to U.S. Provisional Patent Application Ser. No. 60/669,093, filed Apr. 7, 2005.

### FIELD OF THE INVENTION

The present invention relates generally to the field of machine tools. More specifically, the present invention relates generally to methods of and apparatuses for increasing stability and/or preventing chatter in a machine tool assembly.

### BACKGROUND

One area of manufacturing research that has made significant technological advancements in recent years is high-speed machining. Machine improvements include new spindle designs for higher rotational speed, torque, and power; increased slide speeds, accelerations, and direct drive linear motor technology; and new machine designs for lower moving mass. The combination of new machine technology and tool material/coating developments makes high-speed machining a viable alternative to other manufacturing processes. For example, high-speed machining has been applied in the aerospace industry, where the dramatic increases in material removal rates made possible using high-speed machining techniques have allowed designers to replace assembly-intensive sheet metal build-ups with monolithic aluminum components, resulting in substantial cost savings.

However, during a metal cutting operation, any vibratory motion between a cutting tool and workpiece may lead to non-beneficial cutting performances. Furthermore, such vibration may cause the cutting tool or the machine tool to become damaged. Excessive vibrations, frequently called “chatter,” between the cutting element of a machine tool and the surface of the workpiece cause poor surface finish, tool breakage and other unwanted effects that have long plagued machining operations. Such vibrations arise especially when the tool includes a long unsupported length that will permit deflection of the tool. When chatter does occur the machining parameters should be changed and as a result productivity may be adversely affected. In machining operations, chatter is also one of the primary limitations to high material removal rates.

Many research efforts geared toward the understanding and avoidance of chatter have been carried out. This work has led to the development of stability lobe diagrams that identify stable and unstable cutting zones as a function of the chip width and spindle speed. However, the methods used to produce these diagrams, whether analytic or time-domain, require knowledge of the tool point dynamics. The required dynamic model is typically obtained using impact testing, where an instrumented hammer is used to excite the tool at its free end (i.e., the tool point) and the resulting vibration measured using an appropriate transducer, typically a low mass accelerometer. However, due to the large number of spindle, holder, and tool combinations, the required testing time may be significant.

One research effort, in particular, is set forth in U.S. Pat. No. 5,170,358 to Delio. In this reference, the cutting signal obtained while machining is monitored and the spectral content is observed to identify preferred spindle speeds for chatter avoidance. However, this reference requires that the measurements be performed after cutting tests. The method makes no attempt to produce a pre-process stability lobe diagram. Rather, by using information obtained during an actual chattering (unstable) cut at a selected axial depth of cut, recommendations for chatter free spindle speed(s) may be made.

To produce a stability lobe diagram, the dynamic response of the machine-spindle-holder-tool (as reflected at the free end of the tool, or tool point) should be known. This data may be obtained by performing a dynamic test on the machine-spindle-holder-tool in question, but the dynamic response changes if a new holder or tool (or new tool length) is used, so the measurement should be repeated. This requirement is often not practical for a production environment.

Accordingly, it would be beneficial to provide a model that is able to predict a tool point response based on minimum input. It would also be beneficial to provide a model that is able to predict a tool point response to permit a stability lobe diagram to be created for a particular spindle-holder-tool.

### SUMMARY

Accordingly, the present invention provides predictions of tool point responses for machining applications. The present invention provides the predictions based upon a measurement of the spindle and models or measurements of the holder and tool.

One embodiment of the invention is a system for predicting a tool point response of a spindle-holder-tool assembly used for high-speed machining applications. The system can include a displacement-to-force receptance determining module for determining direct and cross displacement-to-force receptances of a standard holder based on received data. The received data, more particularly, can be displacement-to-force measurements taken at different rotating speeds of the spindle.

The system further can include a direct receptances determining module for determining direct receptances at a free end of the standard holder based upon the determined direct and cross displacement-to-force receptances of the standard holder. Additionally, the system can include a decomposition module for simulating a decomposition of the standard holder into a plurality of subassemblies comprising a spindle-holder base subassembly and an extended holder subassembly, the decomposition based upon inverse receptance coupling. The system also can include a subassembly receptances determining module for determining spindle-holder base subassembly receptances based upon the simulated decomposition of the standard holder.

Another embodiment of the invention is a method for predicting a tool point response of a spindle-holder-tool assembly used for high-speed machining applications. The method can include determining direct and cross displacement-to-force receptances of a standard holder secured in the spindle. More particularly, the direct and cross displacement-to-force receptances can be based upon a plurality of displacement-to-force measurements taken at different rotating speeds of the spindle.

The method also can include determining, based upon the determined direct and cross displacement-to-force receptances of the standard holder, direct receptances at a free end of the standard holder. Additionally, the method can include performing an inverse receptance coupling to simulate a decomposition of the standard holder into a plurality of subassemblies, the plurality of subassemblies comprising a spindle-holder base subassembly and an extended holder subassembly. The method further can include determining spindle-holder base subassembly receptances based upon the simulated decomposition of the standard holder.

Yet another embodiment of the invention is a method for determining a stability lobe diagram that graphically depicts regions of stable and unstable process parameter combinations for performing high-speed machining. The method can include determining spindle receptances using a standard holder model and based upon a plurality of measurements taken at different rotating speeds of the spindle. The method also can include coupling a spindle model to an extended holder model using a first connection. Additionally, the method can include coupling a tool model to the spindle-holder using a second connection to develop a model of the spindle-holder-tool assembly. The method further can include generating the stability lobe diagram for the spindle-holder-tool.

### BRIEF DESCRIPTION OF THE DRAWINGS

Other objects, features and advantages of the present invention will become apparent upon reading the following detailed description, while referring to the attached drawings, in which:

FIG. 1 is a schematic diagram of a system for predicting a tool point response of a high-speed machining application, according to one embodiment of the invention.

FIG. 2 is a schematic diagram of an assembly having two rigidly connected substructures that can represent a spindle-holder assembly whose performance is analyzed by the system of FIG. 1.

FIG. 3 is a schematic diagram of an exemplary spindle-holder-tool model which can be analyzed by the system of FIG. 1

FIG. 4 is an exploded view of a spindle standard holder, according to another embodiment of the present invention

FIG. 5 is an exemplary stability lobe diagram generated according to yet another embodiment of the invention.

FIG. 6 is a plot showing the measured and predicted results of a spindle-holder for a first example of the invention.

FIG. 7 is a plot showing the measured and predicted results of a spindle-holder-tool for a second example of the invention.

FIG. 8 is a schematic diagram of a system for generating frequency response predictions for a rotating spindle-holder-tool assembly, according to still another embodiment of the invention.

FIG. 9 is a schematic diagram of a system for generating frequency response predictions for a rotating spindle-holder-tool assembly, according to yet another embodiment of the invention.

FIG. 10 is a schematic diagram of an exemplary solid-geometry holder for which FRF predictions were obtained using the system illustrated in FIG. 9.

FIG. 11 is a pair of plots of exemplary FRF predictions obtained according to the invention.

FIG. 12 is a pair of plots of exemplary FRF predictions obtained according to the invention.

FIG. 13 is a pair of plots of exemplary FRF predictions obtained according to the invention.

### DETAILED DESCRIPTION

The present invention is more particularly described in the following description and examples that are intended to be illustrative only since numerous modifications and variations therein will be apparent to those skilled in the art. As used in the specification and in the claims, the singular form “a,” “an,” and “the” may include plural referents unless the context clearly dictates otherwise.

The present invention encompasses a system and related methods for predicting tool point responses of high-speed machining applications. One aspect of the invention is a technique for dividing a spindle-holder-tool assembly into multiple substructures, which can generally be characterized as a spindle-holder base, extended holder, and tool. Tool and extended holder receptances can be determined analytically, as described herein. Spindle holder base subassembly receptances can be determined based upon empirical data derived using a standard, or model, test holder and performing certain calculations, as also described herein.

### Receptance Coupling Structure Analysis

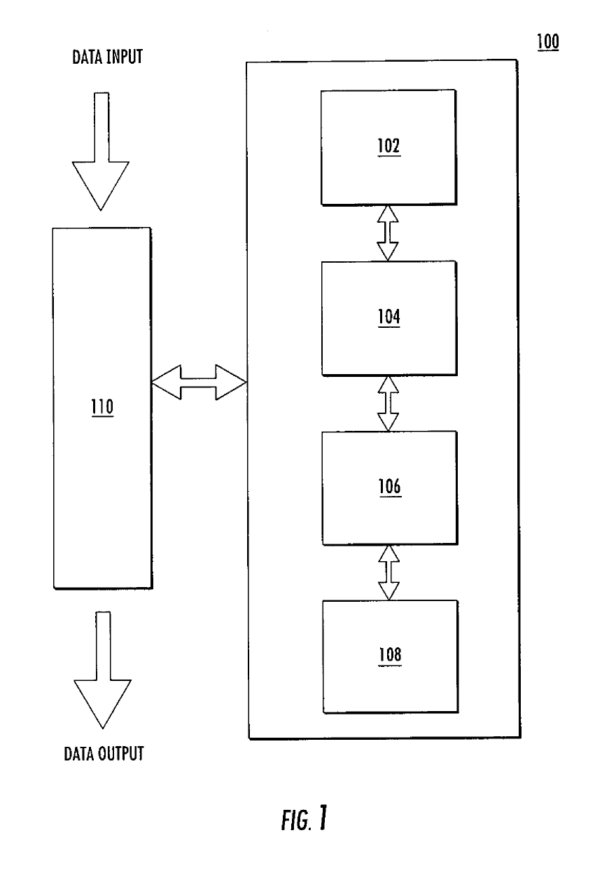

Referring initially to FIG. 1, a system 100 for predicting a tool point response of a high-speed machining application, according to one embodiment, is schematically illustrated. The system 100 illustratively includes a displacement-to-force receptance determining module 102, a direct receptances determining module 104, a decomposition module 106, and a subassembly receptances determining module 108, each of the modules being communicatively linked to one another. The modules 102-108 cooperatively operate to produce tool point predictions according to the techniques described herein. The predictions, as also described herein, are generated based on received receptance data, the data being manipulated by the respective modules 102-108.

Illustratively, the system 100 further includes an input/output (I/O) interface 110, as will be readily understood by one of ordinary skill in the art. The receptance data as well as the predictions generated by data manipulation performed by the respective modules 102-108 are received and supplied, respectively, via the I/O interface 110. The modules 102-108 can be implemented in dedicated hardwired circuitry for performing the functions described herein. Alternatively, the modules 102-108 can be implemented in software code configured to run on one or more logic-based processors. According to still another embodiment, the modules can be implemented in a combination of hardwired circuitry and software code.

Operatively, the displacement-to-force receptance determining module 102 determines direct and cross displacement-to-force receptances of a standard holder based on received data. The received data, more particularly, can be generated by inserting a standard holder of a simple geometry into the spindle and measuring the direct and cross dynamic responses of the spindle-holder assembly.

The direct receptances determining module 104 determines direct receptances (both translational and rotational) at the free end of the standard holder (when inserted in the spindle) based upon the determined direct and cross displacement-to-force receptances. The decomposition module 106 simulates a decomposition of the standard holder. More particularly, the decomposition module 106 can decompose the standard holder into a plurality of subassemblies. According to one embodiment, the plurality of subassemblies includes a spindle-holder base subassembly and an extended holder subassembly. As described more particularly below, the decomposition performed by the decomposition module 106 is based upon inverse receptance coupling. Additionally, the subassembly receptances determining module 108 then determines spindle-holder base subassembly receptances based upon the simulated decomposition of the standard holder. Once the spindle-holder base subassembly receptances are known, any combination of holder and tool can be coupled (in simulation) to this result in order to predict the specific spindle-holder-tool dynamic response at the free end of the tool.

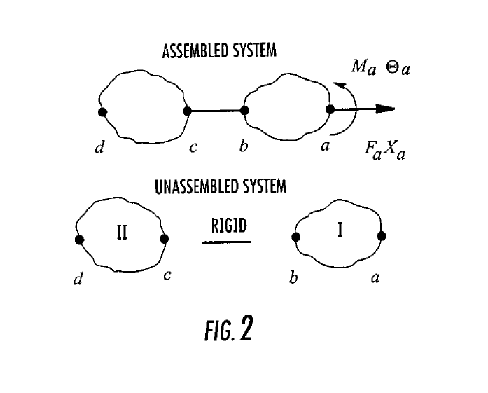

The theoretical basis of the procedures performed by the respective modules 102-108 follows from the fact that components can be represented by spatial mass, stiffness and damping data, modal data, or receptances. The latter representation is beneficial in situations where the assembly receptances are the selected analysis output, as is the case in one embodiment of the present invention. For an assembly having two rigidly connected substructures, as shown in FIG. 2, the assembly receptance, Gⱼₖ(ω), can be expressed as shown in Eq. (1), where ω is the frequency, Xⱼ and Θⱼ are the assembly displacement and rotation at coordinate j, and Fₖ and Mₖ are the force and moment applied to the assembly at coordinate k. If coordinate j is coincident with coordinate k, the receptance is referred to as a direct receptance; otherwise, it is a cross receptance. For the purposes of this application, the nomenclature Gⱼₖ(ω) is used to describe the receptances that are produced when two substructures (or subassemblies) are coupled to produce the final assembly. The nomenclature GSⱼₖ(ω) will replace Gⱼₖ(ω) in all relevant equations when two substructures (or subassemblies) are coupled that do not form the final assembly.

$${G}_{jk} ( ω ) = [ \begin{matrix}\frac{{X}_{j}}{{F}_{k}} & \frac{{X}_{j}}{{M}_{k}} \\ \frac{{Θ}_{j}}{{F}_{k}} & \frac{{Θ}_{j}}{{M}_{k}}\end{matrix} ] = [ \begin{matrix}{H}_{jk} & {L}_{jk} \\ {N}_{jk} & {P}_{jk}\end{matrix} ] \qquad ( 1 )$$

The substructure receptances, Rⱼₖ(ω), are defined in Eq. (2), where xⱼ and θⱼ are the substructure displacement and rotation at coordinate j, and fₖ and mₖ are the force and moment applied to the substructure at coordinate k.

$${R}_{jk} ( ω ) = [ \begin{matrix}\frac{{x}_{j}}{{f}_{k}} & \frac{{x}_{j}}{{m}_{k}} \\ \frac{{θ}_{j}}{{f}_{k}} & \frac{{θ}_{j}}{{m}_{k}}\end{matrix} ] = [ \begin{matrix}{h}_{jk} & {l}_{jk} \\ {n}_{jk} & {p}_{jk}\end{matrix} ] \qquad ( 2 )$$

Based on the coordinates illustrated in FIG. 2, the equations to determine the assembly direct receptances, Gₐₐ(ω) and G_{dd}(ω), and the assembly cross receptances, G_{ad}(ω) and G_{da}(ω), may be written as a function of the substructure receptances as shown in Eqs. (3-6), where rigid connections have been applied.

$$\begin{matrix}{G}_{aa} ( ω ) = [ \begin{matrix}\frac{{X}_{a}}{{F}_{a}} & \frac{{X}_{a}}{{M}_{a}} \\ \frac{{Θ}_{a}}{{F}_{a}} & \frac{{Θ}_{a}}{{M}_{a}}\end{matrix} ] & ( 3 ) \\ = {R}_{aa} ( ω ) - {{R}_{ab} ( ω ) [ {R}_{bb} ( ω ) + {R}_{cc} ( ω ) ]}^{- 1} {R}_{ba} ( ω ) & \\ {G}_{dd} ( ω ) = [ \begin{matrix}\frac{{X}_{d}}{{F}_{d}} & \frac{{X}_{d}}{{M}_{d}} \\ \frac{{Θ}_{d}}{{F}_{d}} & \frac{{Θ}_{d}}{{M}_{d}}\end{matrix} ] & ( 4 ) \\ = {R}_{dd} ( ω ) - {{R}_{dc} ( ω ) [ {R}_{bb} ( ω ) + {R}_{cc} ( ω ) ]}^{- 1} {R}_{cd} ( ω ) & \\ {G}_{ad} ( ω ) = [ \begin{matrix}\frac{{X}_{a}}{{F}_{d}} & \frac{{X}_{a}}{{M}_{d}} \\ \frac{{Θ}_{a}}{{F}_{d}} & \frac{{Θ}_{a}}{{M}_{d}}\end{matrix} ] & ( 5 ) \\ = {{R}_{ab} ( ω ) [ {R}_{bb} ( ω ) + {R}_{cc} ( ω ) ]}^{- 1} {R}_{cd} ( ω ) & \\ {G}_{da} ( ω ) = [ \begin{matrix}\frac{{X}_{d}}{{F}_{a}} & \frac{{X}_{d}}{{M}_{a}} \\ \frac{{Θ}_{d}}{{F}_{a}} & \frac{{Θ}_{d}}{{M}_{a}}\end{matrix} ] & ( 6 ) \\ = {{R}_{dc} ( ω ) [ {R}_{bb} ( ω ) + {R}_{cc} ( ω ) ]}^{- 1} {R}_{ba} ( ω ) & \end{matrix}$$

To populate the substructure receptance matrices, measurement and modeling can be applied. Common modeling options include closed-form expressions for uniform Euler-Bernoulli beams and finite element solutions (which may incorporate the Timoshenko beam model), as will be readily understood by one of ordinary skill in the art.

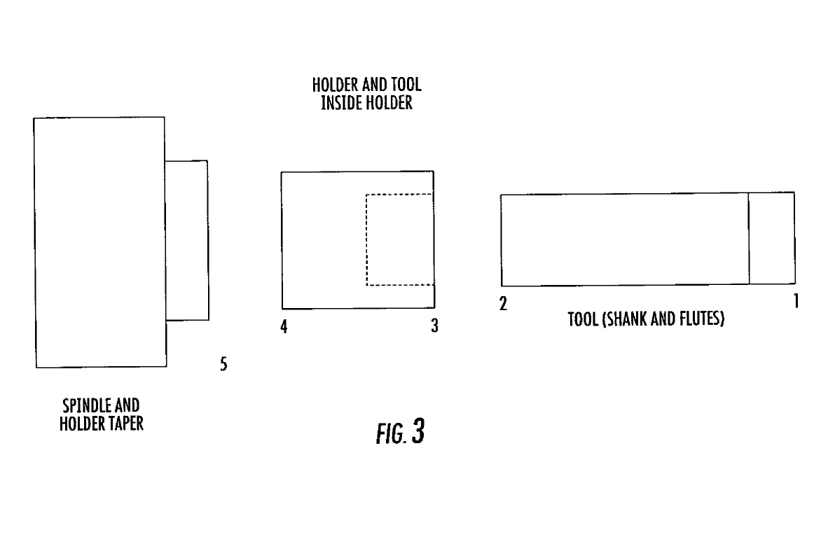

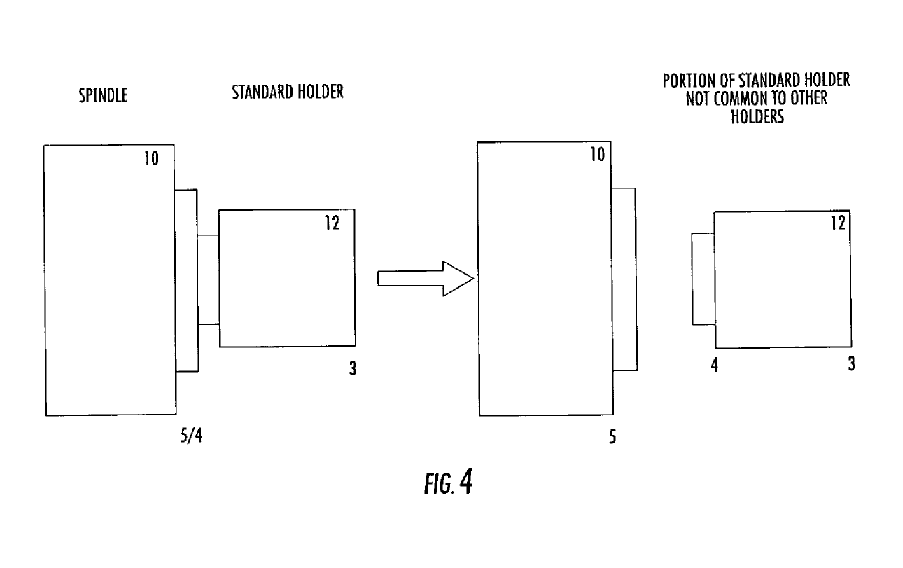

To further illustrate the procedures performed by the system 100, an exemplary model is used. The model is schematically represented in FIG. 3 and is composed of three components and five coordinates. As shown, the five coordinates are labeled 1 through 5. The tool free end 1 and location along the shank where the tool is inserted in the holder 2 are two of the coordinates. Coordinate 3 is at the end of the holder, and coordinate 4 is located at the base of the holder. The free end of the spindle where the holder taper is inserted is coordinate 5. The system 100 determines the receptances at the free end of the spindle-holder base subassembly, GS₅₅(ω). Firstly, the standard holder displacement-to-force direct and cross receptances are determined by the displacement-to-force receptance determining module 102. The standard holder geometry can be selected to generate data that approximates a broad range of potential holders. Secondly, the results generated by the displacement-to-force receptance determining module 102 are manipulated by the direct receptances determining module 104 to determine the three other direct receptances at the free end of the standard holder. Thirdly, the section of the standard holder which is not common to other holders is removed using inverse receptance coupling to determine all four spindle-holder base subassembly receptances, as schematically illustrated in FIG. 4.

Once the standard holder is mounted in a spindle, the four subassembly receptances are determined by measuring the direct, H₃₃, and cross, H_{33b}, and/or H_{33c}, displacement-to-force receptances on the standard holder, applying a 2^{nd}-order backward finite difference method to find L₃₃ (and, equivalently, N₃₃), and then synthesizing P₃₃. Note that a 1^{st}-order (or higher order) finite difference approach can alternately be selected. For the 1^{st}-order approach, only H₃₃ and H_{33b} are required. For the cross displacement-to-force measurements, the distance between the measurements on the standard holder, S, is preferably selected to increase the difference in relative amplitudes between H₃₃, H_{33b}, and/or H_{33c} without leading to a poor signal-to-noise ratio for the H_{33b} and/or H_{33c} measurements (i.e., many of the lower frequency spindle-holder modes resemble a fixed-free fundamental mode shape and have very small amplitudes near the spindle face for the bandwidth of interest). Practically, it has been observed that the finite difference results improve as S is increased; however, care should be taken to ensure that the location of the H_{33b} and/or H_{33c} measurements provides sufficient signal-to-noise. The receptance L₃₃ is determined from the measured displacement-to-force receptances using Eq. (7) in the 2^{nd}-order case. By reciprocity, N₃₃ may be set equal to L₃₃. The remaining receptance, P₃₃, is synthesized from H₃₃, L₃₃, and N₃₃, as shown in Eq. (8).

$$\begin{matrix}{L}_{33} = \frac{3 {H}_{33} - 4 {H}_{33 b} + {H}_{33 c}}{2 S} & ( 7 ) \\ {P}_{33} = \frac{{Θ}_{3}}{{M}_{3}} = \frac{{F}_{3}}{{X}_{3}} \frac{{X}_{3}}{{M}_{3}} \frac{{Θ}_{3}}{{F}_{3}} = \frac{1}{{H}_{33}} {L}_{33} {N}_{33} = \frac{{L}_{33}^{2}}{{H}_{33}} & ( 8 )\end{matrix}$$

Due to the subtraction of the similarly scaled H₃₃, H_{33b}, and/or H_{33c} receptances, noise in the measurement data may detrimentally affect the quality of L₃₃ and N₃₃ (produced by the finite-difference method) and, therefore, P₃₃. To reduce the noise effect, the measured receptance data may be smoothed using a Savitzky-Golay filter, for example, which performs a local polynomial regression to determine the smoothed value for each data point, or equivalent filter prior to the application of Eq. 7. Other smoothing schemes may also be applied as necessary.

The extended holder subassembly for a standard holder can include individual substructures, such as a pair of solid, cylindrical substructures, designated for convenience as substructures I and II. However, it is not required that the substructures be solid or cylindrical. Equations (9-12) provide the direct and cross extended holder subassembly receptance matrices, where rigid coupling has been applied. These equations were determined from Eqs. (3-6) by appropriate substitutions.

$$\begin{matrix}{GS}_{33} ( ω ) = [ \begin{matrix}\frac{{X}_{3}}{{F}_{3}} & \frac{{X}_{3}}{{M}_{3}} \\ \frac{{Θ}_{3}}{{F}_{3}} & \frac{{Θ}_{3}}{{M}_{3}}\end{matrix} ] & ( 9 ) \\ = {R}_{33} ( ω ) - {{R}_{33 a} ( ω ) [ {R}_{3 a 3 a} ( ω ) + {R}_{3 b 3 b} ( ω ) ]}^{- 1} {R}_{3 a 3} ( ω ) & \\ {GS}_{44} ( ω ) = [ \begin{matrix}\frac{{X}_{4}}{{F}_{4}} & \frac{{X}_{4}}{{M}_{4}} \\ \frac{{Θ}_{4}}{{F}_{4}} & \frac{{Θ}_{4}}{{M}_{4}}\end{matrix} ] & ( 10 ) \\ = {R}_{44} ( ω ) - {{R}_{43 b} ( ω ) [ {R}_{3 b 3 b} ( ω ) + {R}_{3 a 3 a} ( ω ) ]}^{- 1} {R}_{3 b 4 } ( ω ) & \\ {GS}_{34} ( ω ) = [ \begin{matrix}\frac{{X}_{3}}{{F}_{4}} & \frac{{X}_{3}}{{M}_{4}} \\ \frac{{Θ}_{3}}{{F}_{4}} & \frac{{Θ}_{3}}{{M}_{4}}\end{matrix} ] & ( 11 ) \\ = {{R}_{33 a} ( ω ) [ {R}_{3 a 3 a} ( ω ) + {R}_{3 b 3 b} ( ω ) ]}^{- 1} {R}_{3 b 4} ( ω ) & \\ {GS}_{43} ( ω ) = [ \begin{matrix}\frac{{X}_{4}}{{F}_{3}} & \frac{{X}_{4}}{{M}_{3}} \\ \frac{{Θ}_{4}}{{F}_{3}} & \frac{{Θ}_{4}}{{M}_{3}}\end{matrix} ] & ( 12 ) \\ = {{R}_{43 b} ( ω ) [ {R}_{3 a 3 a} ( ω ) + {R}_{3 b 3 b} ( ω ) ]}^{- 1} {R}_{3 a 3} ( ω ) & \end{matrix}$$

The spindle-holder base subassembly receptance matrix, G₃₃(ω), can be expressed as shown in Eq. 13 by rewriting Eq. 3. The left hand side of this equation is known once the steps described above are completed. Also, the extended holder subassembly receptances, GS₃₃, GS₄₄, GS₃₄, and GS₄₃, are determined using the equations provided above. Therefore, Eq. 13 may be rewritten to solve for the spindle-holder base subassembly receptances, GS₅₅(ω). See Eq. 14.

$$\begin{matrix}{G}_{33} ( ω ) = [ \begin{matrix}{H}_{33} & {L}_{33} \\ {N}_{33} & {P}_{33}\end{matrix} ] & ( 13 ) \\ = {GS}_{33} ( ω ) - {{GS}_{34} ( ω ) [ {GS}_{44} ( ω ) + {GS}_{55} ( ω ) ]}^{- 1} {GS}_{43} ( ω ) & \\ {GS}_{55} ( ω ) = [ \begin{matrix}\frac{{x}_{5}}{{f}_{5}} & \frac{{x}_{5}}{{m}_{5}} \\ \frac{{θ}_{5}}{{f}_{5}} & \frac{{θ}_{5}}{{m}_{5}}\end{matrix} ] & ( 14 ) \\ = {{GS}_{43} ( ω ) [ {GS}_{33} ( ω ) - {G}_{33} ( ω ) ]}^{- 1} {GS}_{43} ( ω ) - {GS}_{44} ( ω ) & \end{matrix}$$

Once the spindle-holder base subassembly receptances, GS₅₅(ω), have been determined, the assembly response is determined by coupling the desired substructures. As the number of substructures is increased, the basic procedure remains the same; however, substructure I is first coupled to substructure II, then the resulting subassembly is coupled to substructure III, and so on to produce the required assembly receptances. This may be done for any number of substructures.

For example, the spindle-holder base subassembly may be coupled to the extended holder subassembly using Eq. (13) to determine the receptances at the free end of the holder, G₃₃(ω). Euler-Bernoulli, Timoshenko or other beam models may be applied to develop the extended holder receptances.

To predict the tool point dynamics, the spindle-base receptances determined by the subassembly receptances determining module 108 can be coupled to models of the desired holder and tool. The assembly can, in one embodiment, be divided into the spindle-holder base subassembly and a selected number of substructures of differing diameters that represent the holder and tool. Each substructure may be presumed to be a hollow or solid steel cylindrical beam according to the substructure geometry. In one embodiment, all substructures may be modeled using a composite modulus and mass for the portions of the holder with the tool inserted to account for the material differences between the holder and tool, if applicable. The mass expression for these substructures may be replaced with the composite mass shown in Eq. 15, where ρₕ and ρₜ are the density of the holder and tool, respectively and dₒ and dᵢ are the outer and inner diameters, respectively.

$$\begin{matrix}m = \frac{π ( {ρ}_{h} ( {d}_{o}^{2} - {d}_{i}^{2} ) + {ρ}_{t} {d}_{i}^{2} ) L}{4} & ( 15 ) \\ EI = {E}_{h} {I}_{h} + {E}_{t} {I}_{t} = \frac{{E}_{h} π ( {d}_{o}^{4} - {d}_{i}^{4} ) + {E}_{t} π {d}_{i}^{4}}{64} & ( 16 )\end{matrix}$$

After the spindle-holder base subassembly receptances have been obtained, the next step is to rigidly or flexibly couple the extended holder and tool substructures to produce the direct and cross extended holder-tool subassembly receptances at the ends. The final step in the procedure is to predict the tool point dynamics by rigidly or flexibly coupling the extended holder-tool subassembly to the spindle-holder base subassembly. With the appropriate coordinate substitution in Eq. 13, the tool point receptance, G₁₁(ω), may be determined according to Eq. 17, where the receptances associated with coordinates 1 and 4 are the direct and cross end receptances at the end of the extended holder-tool subassembly.
G₁₁(ω)=GS₁₁−GS₁₄(GS₄₄+GS₅₅)⁻¹GS₄₁ (17)

For a quill-type or other spindle, the dynamics may vary with quill extension depending on the machine design. For example, bending modes of the quill may become more flexible at longer extensions. Therefore, for some embodiments, the standard holder responses may be recorded at multiple quill positions.

Accordingly, the system 100 and the procedures implemented by the system provide a method for automatically determining predictions for any machine using a single set of measurements. In contrast to conventional systems and procedures, the system 100 and procedures of the present invention do not require hundreds of measurements. The present invention accomplishes this by using the receptance coupling substructure analysis (RCSA) described herein.

To enable RCSA predictions for a wide variety of machine-spindle-holder-tool combinations, a three-component model can be utilized. According to this model, the machine-spindle-holder-tool substructure is separated into three parts: (1) the machine, spindle, holder taper, and portion of the holder nearest the spindle with standard geometry from one holder to another (referred to as the “spindle-holder base subassembly”); (2) the remaining portion of the holder from the base to the free end (referred to as the “extended holder subassembly”); and (3) the cutting tool.

It should be noted from the preceding discussion that the present invention enables the determination of the rotation-to-force/moment and displacement-to-force/moment receptances for the free end of the spindle-holder base subassembly utilizing only displacement-to-force measurements. The procedures, as described herein, involve direct and cross displacement-to-force measurements of a simple geometry standard holder clamped or otherwise secured in the spindle that is to be modeled. The portion of the standard holder beyond the section with consistent geometry from holder to holder can then be removed in simulation using an inverse receptance coupling approach (i.e., decomposition) to identify the four spindle-holder base subassembly receptances. These receptances can then be coupled to models of the actual holder and tool. In this way, the tool point response for any holder and tool combination can be predicted from a single set of measurements completed on the selected machine-spindle.

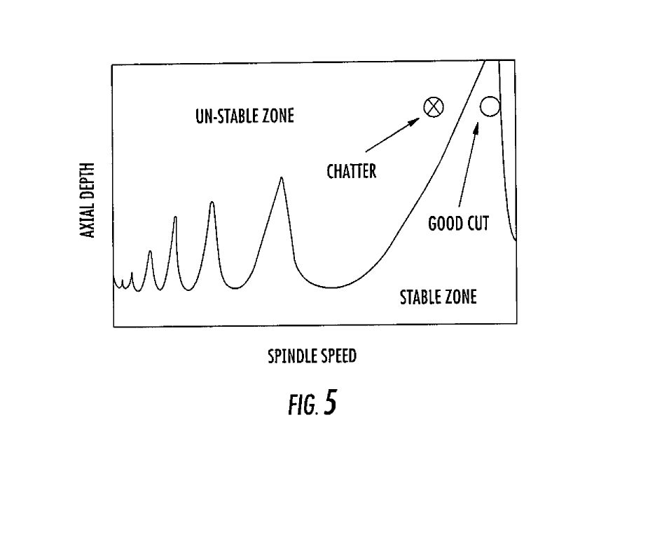

Yet another embodiment of the invention is a method to generate a stability lobe diagram for a selected tool using a series of steps. An exemplary stability lobe diagram is shown in FIG. 5. The steps are designed to predict the dynamics for a spindle-holder-tool assembly using the RCSA model. The procedure can be illustrated using the model illustrated schematically in FIG. 3, which as already noted is composed of three components and five coordinates labeled 1 through 5.

Stability lobe diagram generation, according to this embodiment, includes the step of determining the spindle-base receptances using a standard holder. If the spindle receptances cannot be measured directly, a standard holder of simple geometry can be used, as described above. In one embodiment, the geometry is cylindrical, but it is to be understood that other geometries may also be used including, but not limited to, triangular, rectangular, pentagonal, and hexagonal (as well as solid or hollow). It is also to be understood that, in an alternative embodiment, if the spindle receptances can be measured directly, the methods of the present invention can measure these receptances directly. Also, if the spindle receptances can be accurately predicted, this approach can be used to couple arbitrary holders and tools to the spindle receptances analytically.

When a standard holder is used, the dynamic response of the spindle-standard holder is measured, and then the portion of the holder outside the spindle is removed (using inverse RCSA in simulation) to predict the spindle response.

More specifically, according to this embodiment, the spindle-standard holder subassembly translational receptances are measured and the rotational receptances are calculated at the free end. Next, the spindle-standard holder model is separated into two components. This, again, is schematically illustrated in FIG. 4. The spindle end and taper, or the portion of the holder inside the spindle 10, forms one component. The other component is formed from the geometric-shaped portion of the standard holder 12 that is not common to other holders. In one embodiment, an analytic model of the geometric-shaped portion of the standard holder is developed. In another embodiment, a finite element model of the geometric-shaped portion of the standard holder is developed. In both embodiments, the models are developed using one or more holder dimensions and/or nominal material properties including, but not limited to, the geometry of the holder, Young's modulus, E; density, ρ; and/or structural damping factor, η. Finally, using the RCSA, the spindle dynamic response is determined.

Once the spindle dynamic response has been determined, the spindle dynamic model is coupled to the actual holder using a connection. In one embodiment, the connection is a rigid connection. Again, either an analytic model, in one embodiment, or a finite element model, in an alternative embodiment, is developed using one or more holder dimensions and/or nominal material properties including, but not limited to, Young's modulus, E; density, ρ; and/or structural damping factor, η.

The spindle-holder component is coupled to the tool model using another connection, which can be rigid or flexible with damping included. Using the result from this coupling, the stability lobe diagram can be generated without requiring a new measurement for each holder and tool combination for a particular spindle to complete the method of the present invention according to one embodiment of the present invention.

More specifically, in regards to the specific determinations for obtaining the stability lobe diagrams, a series of analyses is performed, with a plurality of equations used to determine the stability lobe diagram for a particular tool using the predicted tool point frequency response. It is to be understood that the foregoing discussion is for exemplary purposes only and it is contemplated that other analyses and/or equations may be used provided the function of determining a stability lobe diagram for a particular tool is accomplished.

### EXAMPLES

### RCSA

As revealed by the examples presented here, the methods of the present invention are capable of accurately predicting the dynamics for a particular tool. In a first example, a standard holder was replaced with a shrink fit tool holder and the response at the free end of the holder was predicted. In a second example, the standard holder was replaced with a shrink fit tool holder and a tool blank.

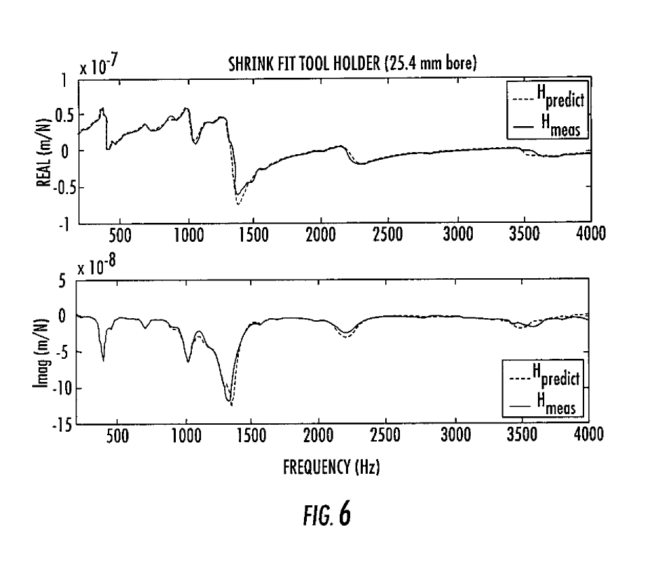

In the first example, a shrink fit holder with a 25.4 mm bore with no tool inserted was predicted. Measurements were performed using a standard holder and inverse RCSA was applied to identify the spindle response. An analytical model of the steel holder was then developed using the holder geometry and nominal material property values for the holder (E=200 GPa, ρ=7800 kg/m³, η=0.0015). This model was then coupled to the inverse RCSA spindle receptances. The measured and predicted assembly responses (at the holder free end) are shown in FIG. 6. As shown, good agreement was observed with multiple spindle modes (e.g. at 400 Hz, 700 Hz, 1000 Hz, 1300 Hz, 2300 Hz, and 3500 Hz) captured by the RCSA model.

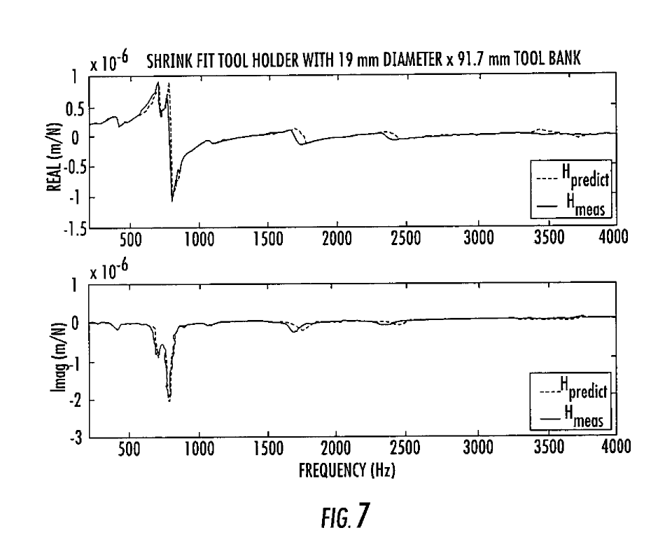

In the second example, a shrink fit holder with a 19.05 mm bore, a 19.05 mm×152 mm long tool blank was predicted. The same spindle receptances (obtained using the standard holder and setup and inverse RCSA) were again applied. Analytical models of the steel holder (E=200 GPa, ρ=7800 kg/m³, η=0.0015) and carbide tool blank (E=585 GPa, ρ=14250 kg/m³, η=0.0015) were developed. These models were then coupled to the inverse RCSA spindle receptances. The tool blank overhang length was 92 mm. The measured and predicted responses at the tool free end are shown in FIG. 7. Good agreement was again seen in this example.

Note that to make this prediction, no frequency response measurements were carried out on the holder or tool. The only information utilized was their geometry and materials. Additionally, no fitting parameters were applied and all connections were presumed to be rigid, although this is not a strict requirement of the invention (flexible connections are also acceptable). The flexibility of this model to couple arbitrary holder-tool combinations to the calculated spindle receptances is one of the primary benefits of the present invention.

FIG. 7 verifies the ability of the present invention method to predict spindle-holder-tool assembly receptances based on the measurement of a standard holder clamped or otherwise secured in the spindle. This predictive capability leads to two potential scenarios: 1) provided the machine-spindle subassembly is sufficiently repeatable as delivered from the manufacturer and the spindle has not been damaged by, for example, a crash or excessive chatter, a single set of measurements completed using a standard holder in a representative spindle could be used to predict the dynamic behavior of any tool-holder combination for all machine-spindle combinations that are manufactured to the same specifications; or 2) sufficient repeatability does not exist between machine-spindle pairs so that the standard holder measurements must be performed on each machine-spindle (prior to leaving the factory, for example). In either case, however, significant reductions in the number of the measurements required to characterize the dynamic behavior of arbitrary tool-holder combinations may be achieved using the present invention.

### Frequency Response Prediction for Rotating Spindle-Holder Tool Subassemblies

Another embodiment of the invention is a system for generating frequency response predictions for a rotating spindle-holder-tool assembly. As already noted, high-speed milling machines used for industrial purposes are typically equipped with a tool magazine that contains a number of different tool-holder combinations or assemblies. In order to reduce measurement times, it is advantageous to predict tool tip response frequency functions (FRF) for the different assemblies rather than performing impact testing to measure the FRF for each assembly. The system for generating frequency response predictions for a rotating spindle-holder-tool assembly, according to this embodiment, predicts the tool tip FRF while overcoming many of the problems inherent in conventional measurements.

Conventional techniques typically measure the tool point FRF at zero spindle speed, an underlying assumption being that the measured FRF remains relatively constant at different spindle speeds. Research indicates, however, that FRFs can change at higher spindle speeds. As described herein, the system according to this embodiment, uses measurements obtained at different rotating speeds of a spindle. Using these measurements taken at different rotating speeds, the invention predicts tool tip FRFs by coupling models of a tool-holder substructure to FRFs of a spindle-machine substructure determined by the inverse receptance coupling techniques described above.

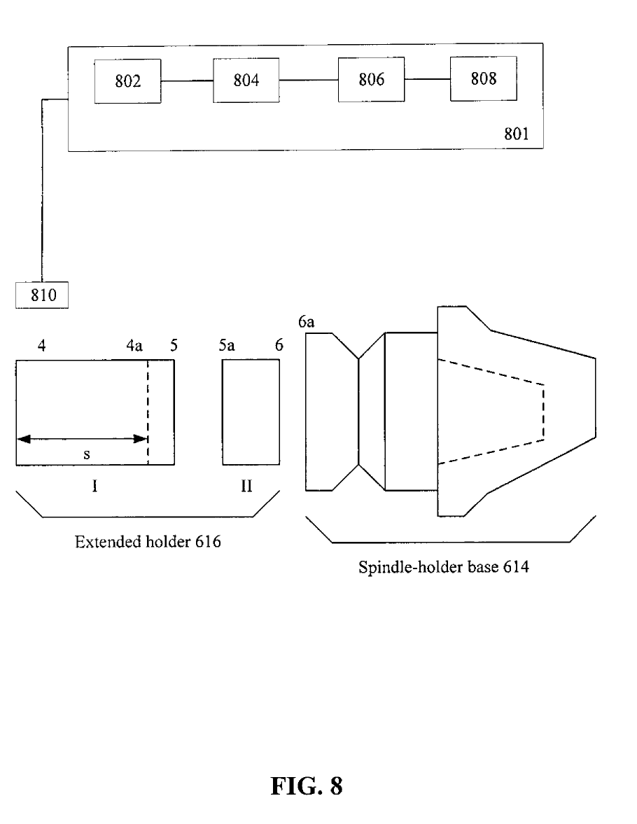

FIG. 8 is schematic view of a system 800 for generating response predictions for a rotating spindle-holder-tool assembly according to this embodiment of the invention. The system 800 illustratively comprises a displacement-to-force receptance determining module 802, a direct receptances determining module 804, a decomposition module 806, and a subassembly receptances determining module 808 communicatively linked to one another, the modules being of the types and having the functionalities described above. In particular, the modules 802-808 cooperatively operate to produce tool point predictions according to the receptance coupling substructure analysis (RCSA) techniques described above. The system 800 further illustratively includes at least one transducer 810 in communication with the plurality of modules 602-608.

Operatively, the system records signals received from the transducer 810. One set of signals can be recorded when an assembly or subassembly is not stimulated. Another set of signals can be recorded when the assembly or subassembly is stimulated, for example, by striking the assembly or subassembly with an instrumented hammer (not shown). The transducer 810 can be positioned to sense a vibration signal at a pre-selected location of the assembly or subassembly when the same or another location of the assembly or subassembly is stimulated.

More particularly, the signals provided by the transducer can be used to obtain and record displacement-to-force measurements. A particular aspect of this embodiment is that a plurality of measurements can be taken at different rotating speeds of a spindle. By taking different measurements at different rotating speeds, the system 800 takes into account directly the influence that the rotating speed of a spindle has on tool tip FRFs.

The procedure effected by the system 800 in predicting a tool tip FRF is further illustrated with respect to an exemplary assembly comprising a first subassembly, illustratively being a spindle-holder base 614, and a second subassembly, illustratively being an extended holder 616. The extended holder 616 can be further decomposed by the simulation described above into portions I and II. In one embodiment, a standard holder, such as a simple-geometry steel standard holder, is used to determine the spindle base receptances R₆ₐ₆ₐ according to the above-described techniques. The standard spindle-holder assembly displacement-to-force receptances are illustratively obtained by placing the sensor 610 at coordinate 4 and exciting the structure at coordinates 4 and 4a (at minimum) to obtain recoded data for computing, respectively, H₄₄ and H₄₄ₐ, the first subscript indicating sensor location and the second indicating the location stimulated. The displacement-to-force receptances, H₄₄ and H₄₄ₐ, are computed based upon the plurality of measurements taken at different rotating speeds of the spindle. In particular, the measurements can be taken at rotating speeds within a range rotating speeds of specific interest for a particular spindle.

As described above, L₄₄ can be determined from the following first-order finite difference equation (although second-order or higher methods may also be applied):

$${L}_{44} = \frac{{H}_{44} - {H}_{44 a}}{S} , \qquad ( 18 )$$

where S is the distance between 4 and 4a. Reciprocity implies that N₄₄=L₄₄, as noted above. P₄₄ is synthesized as previously described according to the following equation:

$${P}_{44} = \frac{{L}_{44} {N}_{44}}{{H}_{44}} = \frac{{L}_{44}^{2}}{{H}_{44}} . \qquad ( 19 )$$

The standard spindle-holder assembly receptance matrix is therefore

$${G}_{44} = [ \begin{matrix}{H}_{44} & {L}_{44} \\ {N}_{44} & {P}_{44}\end{matrix} ] . \qquad ( 20 )$$

Given G₄₄, the spindle-holder receptance matrix R₆ₐ₆ₐ is obtained by decoupling the extended holder:
R₆ₐ₆ₐ=RS₄₆(RS₄₄G₄₄)⁻¹RS₆₄−RS₆₆ (21)
where the extended holder receptances are determined, as described above, from beam models:
RS₄₄=R₄₄−R₄₅(RS₅₅+R₅ₐ₅ₐ)⁻¹R₅₄, (22)
RS₆₆=R₆₆−R₆₅ₐ(RS₅₅+R₅ₐ₅ₐ)⁻¹R₅ₐ₆, (23)
RS₄₆=R₄₅(RS₅₅+R₅ₐ₅ₐ)⁻¹R₅ₐ₆, and (24)
RS₆₄=R₆₅ₐ(RS₅₅+R₅ₐ₅ₐ)⁻¹R₅₄. (25)

The accuracy of the FRF prediction can be improved by determining the standard holder measurements at multiple speeds with the range of speeds of the applicable spindle.

Yet another embodiment of the invention is the implementation of a technique that numerically mitigates or eliminates the runout signal and noise inherent in the acquired data upon which the predictions of frequency response are based. More particularly, the technique applies a time-domain filter to recorded data. The technique segments the vibration signals obtained by stimulating an assembly or subassembly into multiple single-revolution sections. Sections prior to stimulation are selected to construct an average runout signal that is then subtracted from the recorded data. The resulting sequence is repeated over separate stimulations, and the result averaged to reduce noise.

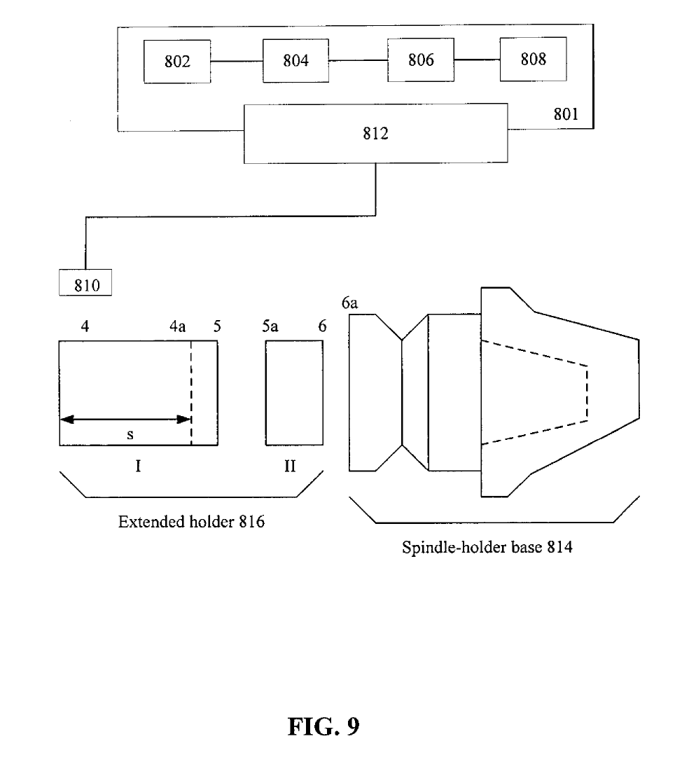

The technique can be added by including with the system 800 a filter 912, as illustrated in FIG. 9. The filter 912 segments the vibration signal into a plurality of single-revolution sections. The sections recorded prior to stimulation are selected to construct an average runout signal that the time-domain filter 612 subtracts from each of the single-revolution sections. Additional sequences are obtained by repeating the procedure, and the results are averaged by the filter 612 to reduce noise. As will be readily understood by one of ordinary skill in the art, the filter can effect a time-domain filtering or a frequency-domain filtering of recorded signals.

### Example

### RCSA Based Upon Measurements for Different Spindle Speeds

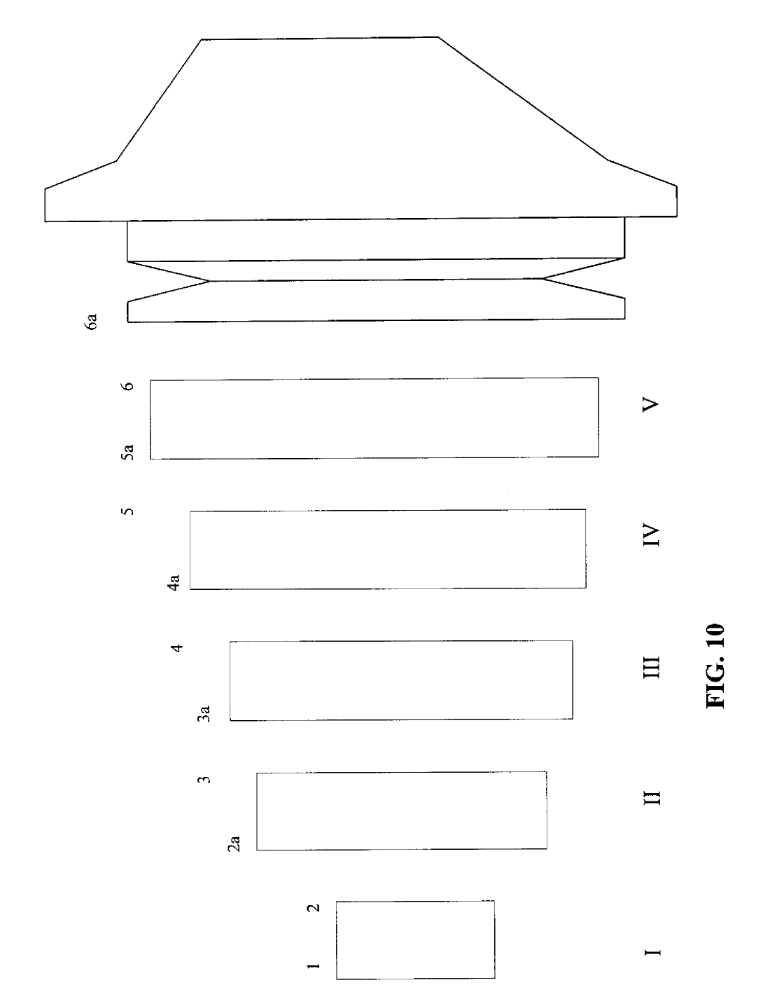

FRF predictions were obtained for an exemplary solid-geometry holder-spindle schematically illustrated in FIG. 10. The Table 1 lists the dimensions of the holder substructures I-V:

TABLE 1
Solid holder substructure dimensions.

| | OD | ID | Length |
|---|---|---|---|
| | (mm) | (mm) | (mm) |
| I | 22.0 | 0 | 11.2 |
| II | 33.3 | 0 | 13.5 |
| III | 41.3 | 0 | 13.2 |
| IV | 47.4 | 0 | 11.6 |
| V | 52.6 | 0 | 13.1 |

The measurements were obtained for a Mikron UCP 600 Vario milling machine equipped with a Step-Tec 20000 rpm, 16 kW spindle. A Lion Precision C1-C capacitance probe was used to record the vibration response and a PCB 086B03 impact hammer was used to excite the system. A TTI LT-880 laser tachometer was used to record the once-per-revolutions signals for runout filtering. MLI's MetalMax 6.0 data acquisition system was used to collect the recorded data.

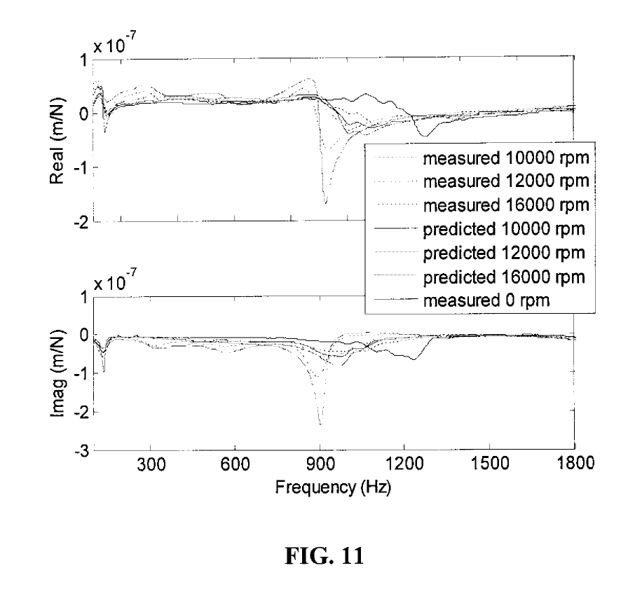

FIG. 11 provides a pair of plots the FRF predictions obtained according to the invention using measurements obtained at different spindle rotating speeds. The observed measurements are also shown. As a comparison of the predicted and observed measurements demonstrates, good agreement of the predictions with the observed measurements was obtained. The zero rpm measurement of the assembly is provided to identify changes in the FRF.

To further verify the accuracy of predictions obtained according to the invention, two 152.4 mm carbide tool blanks, with diameters of 12.7 mm and 25.4 mm, respectively, were inserted in a Regofix collet holder. The overhang length was 127 mm in both instances. The dimensions of the two tool-holder combinations, respectively, are provided in Tables 2 and 3:

TABLE 2
Collet holder with 12.7 mm diameter carbide blank.*

| | OD | ID | |
|---|---|---|---|
| | (mm) | (mm) | Length (mm) |
| I | 12.7 | 0 | 127.0 |
| II | 62.7 | 0 | 25.5 |
| III | 42.0 | 12.7 | 20.6 |
| IV | 42.0 | 35.1 | 11.5 |
| V | 42.0 | 0 | 34.0 |

*I represents the tool overhang section and II-V represent the extended holder sections.

TABLE 3
Collet holder with 25.4 mm diameter carbide blank

| | OD | ID | Length |
|---|---|---|---|
| | (mm) | (mm) | (mm) |
| I | 25.4 | 0 | 127.0 |
| II | 62.7 | 0 | 25.5 |
| III | 42.0 | 25.4 | 20.6 |
| IV | 42.0 | 35.1 | 11.5 |
| V | 42.0 | 0 | 34.0 |

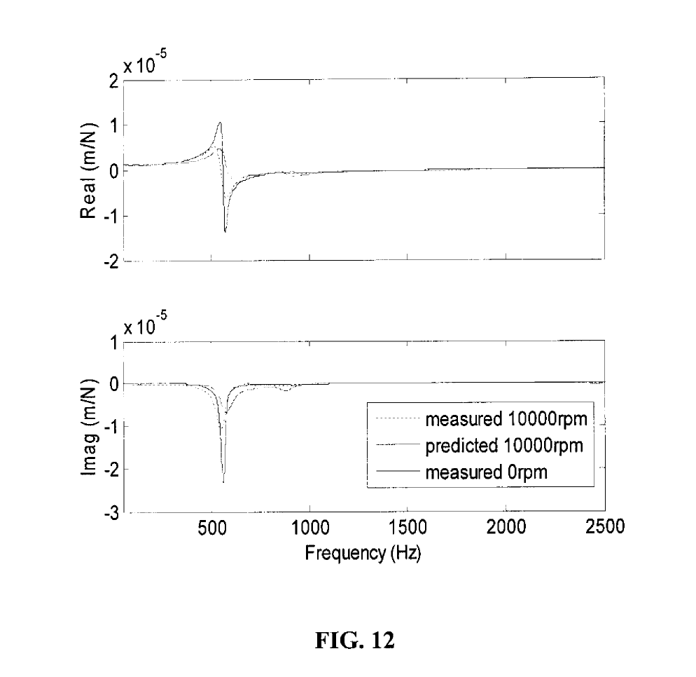

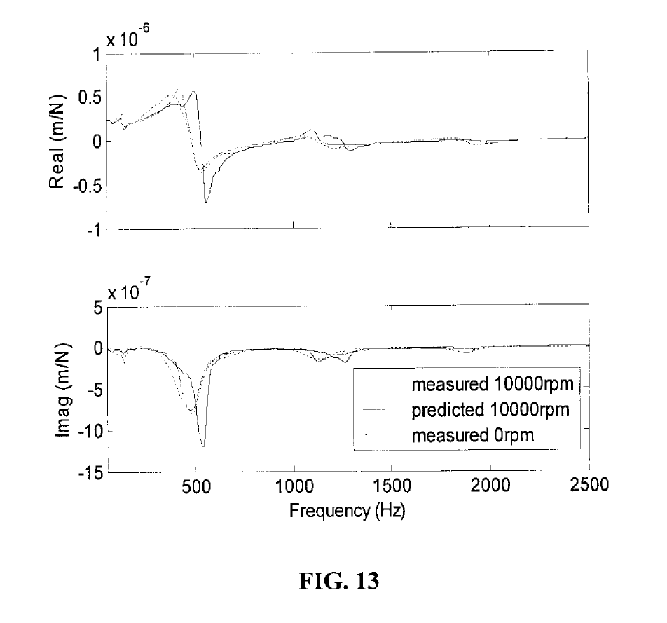

FIG. 12 provides a pair of plots of the predicted FRFs and the observed measurements for the collet holder having 12.7 mm diameter carbide blank. FIG. 13 provides a pair of plots of the predicted FRFs and the observed measurements for the collet holder with 12.7 mm diameter carbide blank. Again, using the RCSA techniques described herein, good agreement between the predicted FRFs and observed measurements was obtained.

The foregoing is provided for purposes of illustrating, explaining, and describing embodiments of this invention. Modifications and adaptations to these embodiments will be apparent to those skilled in the art and may be made without departing from the scope or spirit of this invention.

We claim:

1. A method for predicting a tool point response of a spindle-holder-tool assembly to be used for high-speed machining applications, the method comprising:
determining direct and cross displacement-to-force receptances of a standard holder secured in a spindle based upon a plurality of displacement-to-force measurements taken at different rotating speeds of the spindle;
based upon the determined direct and cross displacement-to-force receptances, determining direct receptances at a free end of the standard holder;
performing an inverse receptance coupling to simulate a decomposition of the standard holder into a plurality of subassemblies comprising a spindle-holder base subassembly and an extended holder subassembly; and
determining spindle-holder base subassembly receptances based upon the simulated decomposition of the standard holder.

2. The method of claim 1, wherein the step of determining direct and cross displacement-to-force receptances of the standard holder secured in the spindle further comprises filtering the plurality of displacement-to-force measurements taken at different rotating speeds of the spindle.

3. The method of claim 2, wherein the filtering comprises a time-domain filtering of the plurality of displacement-to-force measurements taken at different rotating speeds of the spindle.

4. The method of claim 2, wherein the filtering comprises a frequency-domain filtering the plurality of displacement-to-force measurements taken at different rotating speeds of the spindle.

5. The method of claim 1, wherein the step of determining direct receptances at the free end of the standard holder comprises performing a finite difference calculation to determine at least one direct receptance and synthesizing at least one other direct receptance based on the at least one determined direct receptance and the direct displacement-to-force receptance of the standard holder.

6. The method of claim 5, wherein the finite difference calculation is based on calculating a second-order backward finite difference.

7. The method of claim 5, wherein the finite difference calculation is based on calculating a first-order backward finite difference.

8. The method of claim 1, further comprising performing a local polynomial regression using a Savitzky-Golay filter to reduce a noise effect by smoothing measured receptance data.

9. The method of claim 1, wherein the extended holder subassembly comprises a pair of substructures and wherein receptances for each of the pair are determined by calculating Euler-Bernoulli or finite element free-free beam receptances.

10. The method of claim 1, wherein the standard holder has a cylindrical geometry with solid or hollow cross-section.

11. A method for determining a stability lobe diagram that graphically depicts regions of stable and unstable process parameter combinations for performing high-speed machining, and the method comprising the steps of:
determining spindle receptances using a standard holder model and based upon a plurality of measurements taken at different rotating speeds of a spindle;
coupling a spindle model to an extended holder model using a first connection;
coupling a tool model to the spindle-holder using a second connection to develop a model of the spindle-holder-tool assembly; and
generating the stability lobe diagram for the spindle-holder-tool.

12. The method of claim 11, wherein the step of determining spindle receptances further comprises filtering the plurality of measurements taken at different rotating speeds of the spindle.

13. The method of claim 12, wherein the filtering comprises a time-domain filtering of the plurality of displacement-to-force measurements taken at different rotating speeds of the spindle.

14. The method of claim 12, wherein the filtering comprises a frequency-domain filtering the plurality of displacement-to-force measurements taken at different rotating speeds of the spindle.

15. The method of claim 11, wherein the spindle response is determined using a receptance coupling substructure analysis.

16. The method of claim 1, further comprising the steps of:
measuring translational receptances of the spindle-standard holder coupling and calculating rotational receptances at a free end of the standard holder;
simulating separating the spindle and standard holder into two components, wherein a first component is a spindle and taper and a second component is a portion of the standard holder;
developing a model of the second component using a factor selected from at least one holder dimension, at least one material property, or a combination thereof; and
predicting the spindle response using a receptance coupling substructure analysis.

17. The method of claim 16, wherein the model is developed using an analytical model.

18. The method of claim 16, wherein the model is developed using a finite element model.

19. The method of claim 16, wherein the factor is selected from geometry of the holder, Young's modulus, density, a structural damping factor, or a combination thereof.

20. The method of claim 11, wherein the standard holder has a geometry selected from cylindrical, triangular, rectangular, pentagonal, or hexagonal with solid or hollow cross-section.

21. The method of claim 11, wherein the first connection is selected from a rigid connection or a flexible connection.

22. The method of claim 11, wherein the second connection is selected from a rigid connection or a flexible connection.

23. A system for predicting a tool point response of a spindle-holder-tool assembly to be used for high-speed machining applications, the system comprising:
a displacement-to-force receptance determining module for determining direct and cross displacement-to-force receptances of a standard holder based upon a plurality of displacement-to-force measurements taken at different rotating speeds of the spindle;
a direct receptances determining module for determining direct receptances at a free end of the standard holder based upon the determined direct and cross displacement-to-force receptances of the standard holder;
a decomposition module for simulating a decomposition of the standard holder into a plurality of subassemblies comprising a spindle-holder base subassembly and an extended holder subassembly, the decomposition based upon inverse receptance coupling; and
a subassembly receptances determining module for determining spindle-holder base subassembly receptances based upon the simulated decomposition of the standard holder.

24. The system of claim 23, wherein the direct receptances determining module is configured to filter the plurality of displacement-to-force measurements taken at different rotating speeds of the spindle.

25. The system of claim 24, wherein the direct receptances determining module is configured to filter the plurality of displacement-to-force measurements using time-domain filtering.

26. The method of claim 24, wherein the direct receptances determining module is configured to filter the plurality of displacement-to-force measurements using frequency-domain filtering.

27. The system of claim 23, wherein the direct receptances determining module is configured to perform a finite difference calculation to determine at least one direct receptance and synthesize at least one other direct receptance based on the at least one determined direct receptance and the direct displacement-to-force receptance of the standard holder.

28. The system of claim 23, wherein the direct receptances determining module is configured to calculate a second-order backward finite difference.

29. The system of claim 23, wherein the direct receptances determining module is configured to calculate a first-order backward finite difference.

30. The system of claim 23, further comprising a smoothing module for performing a local polynomial regression using a Savitzky-Golay filter to reduce a noise effect by smoothing measured receptance data.

31. The system of claim 17, wherein the decomposition module is configured to simulate a decomposition of the extended holder subassembly into a pair of substructures, and wherein the subassembly receptances determining module is configured to calculate receptances for each of the pair by calculating free-free beam receptances.
